(19) United States
(12) Patent Application Publication
(10) Pub. No.: US 2021/0203241 A1
(43) Pub. Date: Jul. 1, 2021

(54) VARIABLE AND AUTO REGULATED THREE PHASE POWER SOURCE

(71) Applicant: TRiiiON Holdings Pty Ltd, Victoria (AU)

(72) Inventor: Shmuel STEINBERG, Victoria (AU)

(73) Assignee: TRiiiON Holdings Pty Ltd, Victoria (AU)

(21) Appl. No.: 17/273,764

(22) PCT Filed: Sep. 3, 2019
(86) PCT No.: PCT/AU2019/050936

§ 371 Date: Mar. 5, 2021

(30) Foreign Application Priority Data
Sep. 6, 2018 (AU) 2018903328

(51) Int. Cl. H02M 5/14; H01F 30/14; H02J 3/26; H02J 3/38

(52) U.S. Cl. CPC H02M 5/14; H02J 3/381; H02J 3/26; H01F 30/14

(57) ABSTRACT

The present invention provides methods and apparatus for producing a variable and auto regulated three phase power source from an existing three, two or single phase power supply source. Variability and regulation are achieved by producing and controlling two of the three phase nodes/phasors by their amplitude and phase angle displacement. The combination of two independent variable power source inverters, with the incoming unregulated existing power supply source, produces a variable three phase power source in a Wye configuration, that achieves a variable stable and constant regulated Delta configuration three phase power source output.

### CROSS-REFERENCE

This Application claims the benefit of Australian Provisional Patent Application No.: 2018903328, filed on 6 Sep. 2018, the entire contents of which is incorporated herein by reference thereto.

### TECHNICAL FIELD

The present invention relates generally to methods and apparatus for producing or supplying three phase power, and relates particularly, though not exclusively, to methods and apparatus for producing or supplying variable and regulated three phase power. More particularly, the present invention relates to methods and apparatus for producing a variable and auto regulated three phase power source from an existing three, two or single phase power supply source.

### BACKGROUND ART

Any discussion of documents, devices, acts or knowledge in this specification is included to explain the context of the invention. It should not be taken as an admission that any of the material forms a part of the prior art base or the common general knowledge in the relevant art in Australia, or elsewhere on or before the priority date of the disclosure herein.

Electricity generation, transmission, distribution and consumption, is ideally by way of three phase systems. Typically, one or more energy source(s), i.e. fossil fuel(s), hydro, solar, wind, wave, nuclear, biomass, geothermal, etc., is/are used to turn or drive one or more three phase generators which produce three phase electricity. These generators are usually connected to step-up transformers to produce high or very high voltages in order to transmit the electrical energy over long distances in a cost-effective manner. End users are generally connected to a low voltage distribution supply voltage of less than 1000V, which is achieved by way of step-down transformers installed at various locations along the supply chain.

Electricity distribution networks are designed and implemented based on predicted consumption diversity and economic considerations. Like any other infrastructure system, the cost of an electricity distribution network must ultimately pay for itself via the amount of revenue being collected for the consumption of the electricity being produced and distributed throughout the network.

Hence, whilst end users in condensed consumption areas, i.e. in capital cities or densely populated regional areas, may have the option of being connected to the distribution network by any one of a three phase (four wire), two phase (three wire) or single phase (two wire) connection, economic considerations often mean that end users in regional/rural areas with known relatively small loads, and no, or low, demand growth anticipation, only have the option of a single phase (two wire) connection to the distribution network. That is, in such regional/rural areas, for economic reasons, the high/medium voltage distribution is usually supplied by single phase systems, known as: Single Phase (two “actives” only); or, SWER (“Single Wire Earth Return”); or, by Dual SWER systems. SWER systems are favoured over other supply systems in many jurisdictions including in Australia, New Zealand, Canada, Brazil, the United States of America and South Africa, as they are more economical and only require as little as a single (Active) aerial wire—the electrical loop being completed by a convenient ‘Earth Return’ system utilising earth rods embedded into the ground at various locations along the supply chain.

Whilst the use of Single Phase or SWER distribution lines may be convenient for the distribution network, for at least economic reasons, there are of course many circumstances where it is required, or at least desired, to operate a three phase load, such as a three phase motor, in remote or rural areas where only single phase power is available. For example, rural properties such as dairy farms often require loads bigger than 3 kW, for operating vacuum pumps, refrigeration units, air conditioning systems, etc. However, if such properties are only supplied with power via, for example, a SWER system, three phase power is not available unless suitable three phase conversion systems can be readily provided.

A number of substantial advances in the art of converting single phase power, in particular a Single Phase or SWER power supply source, into three phase power, are provided by the methods and apparatus of the present inventor's earlier filed International Patent Application No.: PCT/AU2011/000545, published under WO 2011/140597 A1, on 17 Nov. 2011, and its counterparts in Australia (Patent Nos.: 2011252753 & 2015203054), ARIPO (Patent Nos.: AP3735 & AP4803), New Zealand (Patent Nos.: 604016 & 703741), India (Application Nos.: 10594/DELNP/2012 & 201918016524), South Africa (Patent/Application No.: 2012/09318 & 2019/01759) and the United States of America (Pat. Nos.: 9,083,235 & 9,893,640). The entire contents of these Patents/Applications being incorporated herein by reference thereto.

Even in areas where three, two and single phase power is readily available to end users via the distribution network, the reliability and power quality of the power being supplied by the network can be an issue at times. For example, whilst the Electricity Distribution Code, Version 9A, August 2018, of the Essential Services Commission of the State of Victoria, Australia (hereinafter simply referred to as the “Code”), stipulates (at Clause 4.4.2, Table 1) that for voltage levels less than 1 kV, variations in voltage supply of +10% to −6% at steady state, or +14% to −10% for less than 1 minute, are allowable, in reality, due to the nature of a distribution networks design, construction and operation, voltage levels may, at times, exceed the allowable variations stipulated by the Code. Such variations in supply power can cause problems for end users, especially if they are running equipment such as motors, both single and three phase motors, that are rated for operation within strict voltage levels.

Whilst the methods and apparatus of the present inventor's earlier Patents/Applications identified above work effectively and are reliable at converting a single phase power supply source into a three phase power supply source, problems associated with variations in the input single phase power supply source are not addressed.

A need therefore exists for methods and apparatus for producing a variable and auto regulated three phase power source from an existing three, two or single phase power supply source.

### Disclosure of the Invention

Accordingly, in one aspect, the present invention provides a method for producing a variable and auto regulated three phase power source from an existing three, two or single phase power supply source which includes at least one input active with an input reference, wherein the three phase power source is a three phase Wye having three output actives and an output reference, and the input reference is common to the output reference, the method including the steps of: using the at least one input active as a first output active of the three phase power source; and, producing a second and third variable output active of the three phase power source using at least one first variable power source inverter with variable amplitude and variable phase angle displacement which produces an output of 0° to 360° variable angle displacement with reference to the first output active, and at a variable amplitude with reference to the output reference, and at least one second variable power source inverter with variable amplitude and variable phase angle displacement which produces an output at a 0° to 360° variable angle displacement with reference to the first output active, and at a variable amplitude with reference to the output reference.

Preferably, the at least one first variable power source inverter and/or the at least one second variable power source inverter are powered by the at least one input active, or actives, of the existing three, two or single phase power supply source and/or an auxiliary power supply source.

Preferably, the method further including the steps of: monitoring the amplitude and phase angle displacement of the first output active, and second and third output actives with reference to the first output active, and adjusting the output of the at least one first variable power source inverter and the at least one second variable power source inverter so that the amplitude and phase angle of the second and third output actives substantially regulates the first and second variable power source inverters to produce variable and regulated first to third three phase output actives.

Preferably, the existing three, two or single phase power supply source is selected from the group consisting of: a single phase supply source; a dual phase supply source, a three phase supply source; a single, dual or three phase electricity distribution supply source; an auxiliary local or remote generator(s), wind, solar, wave, chemical or mechanical supply source(s); or, any suitable combination thereof.

Preferably, the auxiliary local or remote power supply source is selected from the group consisting of: a single phase supply source; a dual or three phase supply source; a single, dual or three phase electricity distribution supply source; or, any suitable combination thereof.

According to a further aspect, the present invention provides an apparatus for producing a variable and auto regulated three phase power source from an existing three, two or single phase power supply source which includes at least one input active with an input reference, wherein the three phase power source is a three phase Wye having three output actives and an output reference, and the input reference is common to the output reference, the apparatus including: terminal means for connecting the at least one input active to the apparatus to be used as a first output active of the three phase power source; and, phase generation means for producing a second and third variable output active of the three phase power supply source, wherein the phase generation means includes at least one first variable power source inverter with variable amplitude and variable phase angle displacement which produces an output of 0° to 360° variable angle displacement with reference to the first output active, and at a variable amplitude with reference to the output reference, and at least one second variable power source inverter with variable amplitude and variable phase angle displacement which produces an output at a 0° to 360° variable angle displacement with reference to the first output active, and at a variable amplitude with reference to the output reference.

Preferably, the at least one first variable power source inverter and/or the at least one second variable power source inverter are powered by the at least one input active, or actives, of the existing three, two or single phase power supply source and/or an auxiliary power supply source.

Preferably, the phase generation means further includes monitoring means for monitoring the amplitude and phase angle displacement of the first output active and the second and third output actives with reference to the first output active, and for adjusting the output of the at least one first variable power source inverter and the at least one second variable power source inverter so that the amplitude and phase angle of the second and third output actives substantially regulates the first and second variable power source inverters to produce variable and regulated first to third three phase output actives.

Preferably, the existing three, two or single phase power supply source is selected from the group consisting of: a single phase supply source; a dual phase supply source; a three phase supply source; a single, dual or three phase electricity distribution supply source; an auxiliary local or remote generator(s), wind, solar, wave, chemical or mechanical supply source(s); or, any suitable combination thereof.

Preferably, the auxiliary local or remote power supply source is selected from the group consisting of: a single phase supply source; a dual or three phase supply source; a single, dual or three phase electricity distribution supply source; or, any suitable combination thereof.

These and other essential and/or preferred aspects and features of the present invention will be apparent from the description that now follows.

### BRIEF DESCRIPTION OF THE DRAWINGS

In order that the invention may be more clearly understood and put into practical effect there shall now be described in detail preferred constructions of methods and apparatus for producing a variable and auto regulated three phase power source, from an existing three, two or single phase power supply source, in accordance with the invention. The ensuing description is given by way of non-imitative examples only and is with reference to the accompanying drawings, wherein:

FIGS. 1A to 1C are drawings of various obtuse triangles which are utilised to illustrate cosine theory applicable to the methods and apparatus for producing a variable and auto regulated three phase power source, from an existing three, two or single phase power supply source, in accordance with the present invention;

FIGS. 2A to 2C are various preferred phasor diagrams which illustrate that for a varying reference Wye phasor, the other constructed Wye phasors can be varied by means of amplitude and angle displacement in such a way that the output Delta Phasors of the three phase power source produced in accordance with the methods and apparatus of the present invention may be kept stable at all times;

FIG. 3 is a schematic diagram illustrating the base topology of a preferred embodiment of a circuit or system that can be used to produce a variable and auto regulated three phase power source, from an existing three, two or single phase power supply source, in accordance with the present invention;

FIG. 4 is a schematic diagram illustrating how the preferred circuit or system of FIG. 3 may be used to produce a variable and auto regulated three phase power source, from an existing single phase power supply source, in accordance with a preferred embodiment of the present invention;

FIG. 5 is a schematic diagram illustrating how the preferred circuit or system of FIG. 3 may be used to produce a variable and auto regulated three phase power source, from an existing two phase power supply source, in accordance with a preferred embodiment of the present invention;

FIG. 6 is a schematic diagram illustrating how the preferred circuit or system of FIG. 3 may be used to produce a variable and auto regulated three phase power source, from an existing three phase power supply source, in accordance with a preferred embodiment of the present invention;

FIGS. 7A to 7C are further various preferred phasor diagrams which illustrate how a variable and auto regulated three phase power source, having a non-Code standard output voltage, may be produced in accordance with a further aspect of the present invention;

FIGS. 8A to 8C are preferred time based waveform diagrams, each of which illustrate the amplitude and phase angle displacements of the corresponding phasors of the preferred phasor diagrams of FIGS. 7A to 7C, respectively;

FIG. 9 is a schematic diagram illustrating how a variable and auto regulated three phase power source, having a non-Code standard output voltage, may be produced, from an existing two phase power supply source, in accordance with a further preferred aspect of the present invention;

FIG. 10 is a schematic diagram illustrating how a variable and auto regulated three phase power source, may be produced, from a combination of an existing single phase power supply source and an auxiliary power supply source, in accordance with a further preferred aspect of the present invention;

FIG. 11 is a schematic diagram illustrating how a variable and auto regulated three phase power source, having a non-Code standard output voltage, may be produced, from an existing three phase power supply source, in accordance with a further preferred aspect of the present invention;

FIGS. 12A to 12F are further various preferred phasor diagrams which illustrate how a variable and auto regulated three phase power source, having a ramping up/down mode of operation, may be produced in accordance with a further aspect of the present invention; and,

FIGS. 13A to 13F are preferred time based waveform diagrams, each of which illustrate the amplitude and phase angle displacements of the corresponding phasors of the preferred phasor diagrams of FIGS. 12A to 12F, respectively.

### MODES FOR CARRYING OUT THE INVENTION

The following is a detailed description of the invention with reference to the preferred embodiment(s) shown in the drawings. In the detailed description and in the drawings, like reference numerals refer to like elements throughout. Those elements are intended to show by way of illustration specific embodiments in which the invention may be practiced. It is to be understood that other embodiments may be utilised and that procedural and/or structural changes may be made without departing from the spirit and scope of the invention.

The drawings provided herein are intended to present the relationship between the preferred schematics of the various embodiments of the present invention, the preferred phasor diagrams and the preferred time based waveform diagrams. It will be appreciated to a person skilled in the art that not all possible electrical connections are discussed and/or shown in the drawings, but only those necessary to explain the workings of the various preferred embodiments of the present invention. Furthermore, for simplicity, and given that the Inventor resides in Australia, in a number of the drawings provided herein the exemplary voltage levels and standards are based on those of Australia, in particular those of the State of Victoria, Australia, in accordance with the aforementioned Code. While voltage levels in that Code are in RMS (Root Mean Square), in the various phasor and time based waveform drawings provided herein peak values are generally provided. Accordingly, unless an RMS suffix is utilised in the drawings provided, or discussed herein, the voltage values provided are peak values, a sample of which can be converted to RMS as follows: 324V (sin wt)=230V RMS; 564V (sin wt)=400V RMS; and, 973V (sin wt)=690V RMS. Given that the exemplary voltage levels and standards presented herein are based on those of the aforesaid Code, it will be appreciated that where terms such as “Non-Code”, “non-Code Standard”, or “non-Code standard”, etc., is/are used throughout the description, those terms are intended to refer to voltage levels that are outside the standard voltage levels stipulated in that particular aforesaid Code. Whilst one or more voltage levels presented herein may be outside the standard voltage levels stipulated by the aforesaid Code, such voltage levels may be in compliance with codes of other jurisdictions throughout the world. Hence, one or more of the “non-Code standard” voltages presented hereinafter, may be deemed a “Code standard” voltage in a jurisdiction outside of Australia. Similarly, whilst Australian power systems operate at a frequency of 50 Hz, the present invention is not limited to that frequency alone. That is, the methods and apparatus of the present invention can operate at any other suitable frequency, such as, for example, 60 Hz for the United States of America, and so on. Accordingly, the present invention should not be construed as limited to any one or more of the specific examples provided herein, but instead should be construed broadly within the spirit and scope of the disclosure herein.

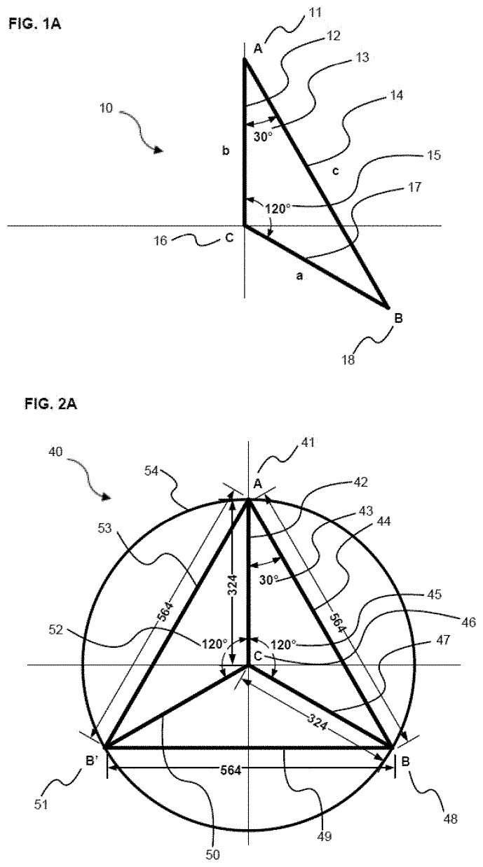

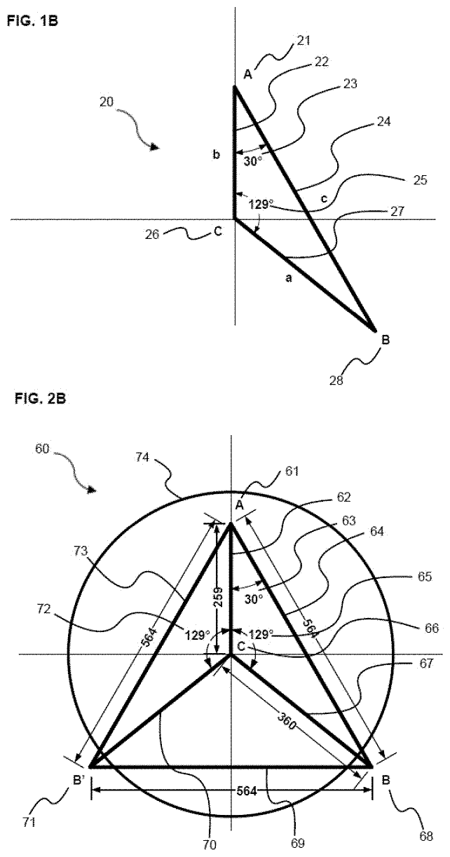

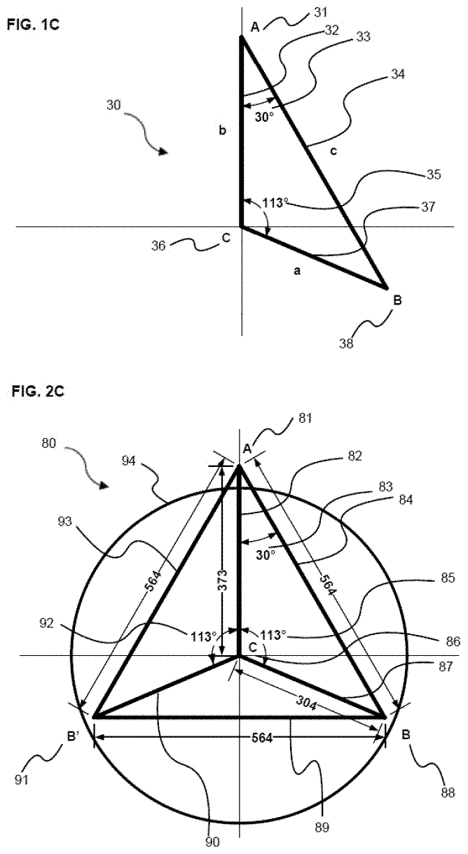

FIGS. 1A to 1C show various obtuse triangles which are utilised to illustrate cosine theory applicable to the methods and apparatus for producing a variable and auto regulated three phase power source, from an existing three, two or single phase power supply source, in accordance with the present invention.

### FIG. 1A—Rules of Cosines—Obtuse Isosceles Triangle:

In FIG. 1A, there is provided an obtuse isosceles triangle 10 with sides a (17), b (12) & c (14), and corresponding opposite angles A (11), B (18) & C (16). The relationship between the sides a (17), b (12) & c (14), and opposite angles A (11), B (18) & C (16), of triangle 10, is given by the rules of cosines in Formulas 1 to 3 as follows:

a²=b²+c²−2*b*c*COS(A) Formula 1

C°=COSH((a²+b²−c²)/(2*a*b)) Formula 1

c²=b²+a²−2*b*a*COS(C) Formula 3

If we apply Formula 3 to triangle 10 of FIG. 1A, with the predefined parameteres:

a(17)=b(12)=1; and,

angle C(16)=120°(15),

### Then:

c(14)=SQRT3, i.e. ˜1.73; and, angle A(11)=30°(13)

Here it is noted that SQRT3 (i.e. ˜1.73) is the standard ratio between the voltage of a three phase Delta system, to the voltage of a single phase Wye in the same system.
FIG. 1B—Rules of Cosines—Obtuse Scalene Triangle with Short Reference:

In FIG. 1B, there is provided an obtuse scalene triangle 20 with sides a (27), b (22) & c (24), and corresponding opposite angles A (21), B (28) & C (26). Where triangle 20 of FIG. 1B varies to that of triangle 10 of FIG. 1A, is that side b (22) of triangle 20 is shorter than that of side b (12) of triangle 10, with the following predefined parameters:

c(24)=1.73;

angle A(21)=30°(23); and

b(22)=0.8

If we apply Formula 1 to triangle 20 of FIG. 1B, then:

a(27)=1.1; and

by applying Formula 2:

angle C(26)=129°(25)

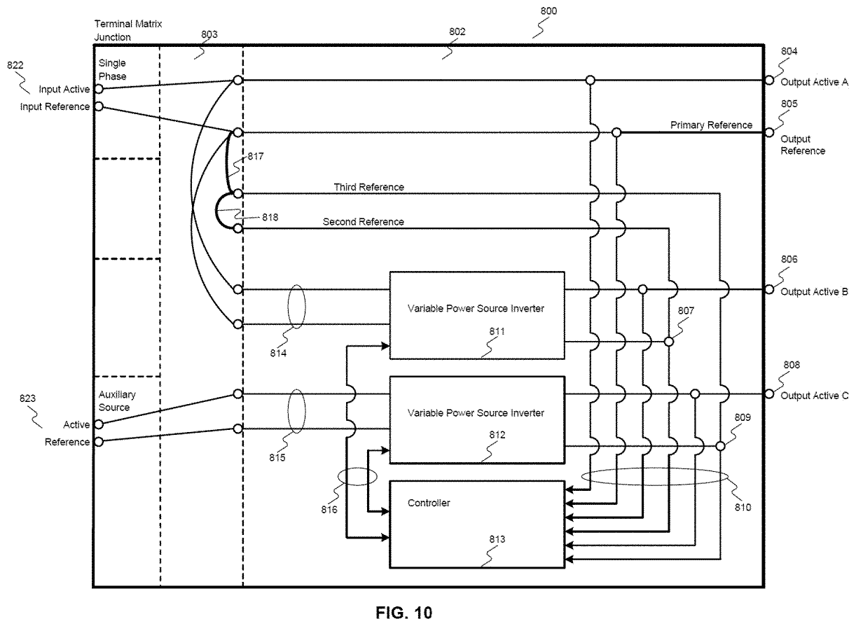

FIG. 10—Rules of Cosines—Obtuse Scalene Triangle with Long Reference:

In FIG. 1C, there is provided an obtuse scalene triangle 30 with sides a (37), b (32) & c (34), and corresponding opposite angles A (31), B (38) & C (36). Where triangle 30 of FIG. 1C varies to that of triangle 10 of FIG. 1A, is that side b (32) of triangle 30 is longer than that of side b (12) of triangle 10, with the following predefined parameters:

c(34)=1.73;

angle A(31)=30°(33); and

b(32)=1.15

If we apply Formula 1 to triangle 30 of FIG. 10, then:

a(37)=0.94; and

by applying Formula 2:

angle C(36)=113°(35)

### Important Note Concerning FIGS. 1A to 1C:

Thus, FIGS. 1A to 1C demonstrate that if side b (22) of triangle 20 of FIG. 1B is shortened by 20%, side a (27) only extends by only 10%. Likewise, if side b (32) of triangle 30 of FIG. 1C is extended by 15%, side a (37) is only shortened by 6%. This is important in the context of the further detailed description of the preferred methods and apparatus of the present invention which now follows.

FIGS. 2A to 2C show various preferred phasor diagrams which illustrate that for a varying reference Wye phasor, the other constructed Wye phasors can be varied by means of amplitude and angle displacement in such a way that the output Delta Phasors of the three phase power source produced in accordance with the methods and apparatus of the present invention may be kept stable at all times.

### FIG. 2A—Regulated Compliant Delta at Compliant Voltage Reference:

In FIG. 2A, there is shown a phasor diagram 40 in the form of an equilateral triangle (nodes ABB′ (41, 48 & 51), with sides 44, 49 & 53) that is a Delta triangle with equal length sides and equal internal angles 60° (not shown). The equilateral Delta triangle of phasor diagram 40 is essentially a mirror reflection of the obtuse isosceles triange 10 of FIG. 1A (ABC, with sides 14, 17 & 12). However, in the phasor diagram 40 of FIG. 2A, the correspending side 42 (was b in FIG. 1A) now represents a Wye connected phasor voltage of 324V @0° (or 230V RMS), which is compliant with the aforementioned Code of the State of Victoria, Australia. Here, if we apply the predefined parameters:

angle A(41)=30°(43);

side 44=564V (or 400V RMS)

Then by applying Formula 1:

Wye phasor 47=324V (or 230V RMS)

And, by applying Formula 2:

angle C(46)=120°(45)

Similarly, Wye phasor 50 also equals 324V (or 230V RMS) (not shown), and the angle between Wye phasor 42 and Wye phasor 50 also equals 120° (52). Accordingly, FIG. 2A discloses a compliant Delta/Wye phasor system, with all Wye phasors' (42, 47 & 50) voltages being equal and balaced by value, and equally displaced by 120°. Similarly, all Delta phasors' (44, 49 & 53) voltages are equal and balanced by value. The circle 54, of FIG. 2A, is provided to demonstrate that at balanced phasors, all nodes (ABB′ (41, 48 & 51)) are on the circle 54.

### FIG. 2B—Regulated Compliant Delta at Under Voltage Reference:

In FIG. 2B, there is shown a phasor diagram 60 in the form of an equilateral triangle (nodes ABB′ (61, 68 & 71), with sides 64, 69 & 73), that is a Delta triangle with equal length sides and equal internal angles 60° (not shown). The equilateral Delta triangle of phasor diagram 60 is essentially a mirror reflection of the obtuse scalene triange 20 of FIG. 1B (ABC, with sides 24, 27 & 22). However, in the phasor diagram 60 of FIG. 2B, the correspending side 62 (was b in FIG. 1B) now represents a Wye connected phasor voltage of 259V @ 0° (that is, 324V—20%), with angle A (61) set to 30° (63), and side 64 set to 564V (or 400V RMS). Based on these parameters:

By applying Formula 1:

Wye phasor 67=360V (or 255V RMS)

And, by applying Formula 2:

angle C(66)=129°(65)

Similarly, Wye phasor 70 also equals 360V (or 255V RMS) (not shown), and the angle between Wye phasor 62 and Wye phasor 70 also equals 129° (72). While the circle (74) is positioned equally on four quadrants like in the case of circle 54 of FIG. 2A, in the embodiment shown in FIG. 2B, none of the phasor nodes (ABB′ (61, 68 & 71) are on the circle 74. Whilst Wye phasor 62 is well within the circle's (74) boundary (259V is 20% less than 324V, and is below the aforesaid Code of compliance that allows up to −10% for a short period), Wye phasors 67 & 70 are outside the circle 74—however only by ˜+11%, which is well within the Code of compliance which allows up to 14% for a short period of time.

### FIG. 2C—Regulated Compliant Delta at Over Voltage Reference:

In FIG. 2C, there is shown a phasor diagram 80 in the form of an equilateral triangle (nodes ABB′ (81, 88 & 91), with sides 84, 89 & 93), that is a Delta triangle with equal length sides and equal internal angles 60° (not shown). The equilateral Delta triangle of phasor diagram 80 is essentially a mirror reflection of the obtuse scalene triange 30 of FIG. 10 (ABC, with sides 34, 37 & 32). However, in the phasor diagram 80 of FIG. 2C, the correspending side 82 (was b in FIG. 10) now represents a Wye connected phasor voltage of 373V (or 264V RMS) @ 0° (that is, 324V+15%), with angle A (81) set to 30° (83), and side 84 set to 564V (or 400V RMS). Based on these parameters:

By applying Formula 1:

Wye phasor 87=304V (or 215V RMS)

And, by applying Formula 2:

angle C (86)=113°(85)

Similarly, Wye phasor 90 also equals 304V (or 215V RMS) (not shown), and the angle between Wye phasor 82 and Wye phasor 90 also equals 113° (92). While the circle (94) is positioned equally on four quadrants like in the case of circle 54 of FIG. 2A, in the embodiment shown in FIG. 2C, none of the phasor nodes (ABB′ (81, 88 & 91) are on the circle 94. Whilst Wye phasor 82 is well outside the circle's (94) boundary (373V is 15% more than 324V, and is just above the aforesaid Code of compliance that allows up to +14% for a short period), Wye phasors 87 & 90 are within the circle 94—however only by ˜−6%, which is well within the Code of compliance which allows up to −10% for a short period of time.

### Important Note Concerning FIGS. 1A to 2C:

It should now be appreciated by way of the above detailed description of FIGS. 1A to 2C, that in accordance with a first important aspect of the present invention, for a varying reference Wye phasor (42, 62 & 82), the other constructed Wye phasors (47 & 50), (67 & 70) & (87 & 90) are configured to vary by means of amplitude and angle displacement in a way that keeps the Delta phasors (44, 49 & 53), (64, 69 & 73) & (84, 89 & 93) auto regulated and stable at 564V (or 400V RMS) at all times. In addition, whilst the reference Wye phasor (42, 62 & 82) may vary by, for example, +20%, the other constructed Wye phasors (47 & 50), (67 & 70) & (87 & 90) only vary by −10%, and similarly, whilst the reference Wye phasor (42, 62 & 82) may vary by, for example, −20%, the other constructed Wye phasors (47 & 50), (67 & 70) & (87 & 90) only vary by around +10%, whilst in both instances the Delta phasors remain regulated and stable at a constant setting of 400V RMS. That is, and referring to FIGS. 2A to 2C, a stable and auto regulated Delta phasor voltage of 564V is maintained at all times, regardless of the variation of the voltage of the reference Wye phasor (42, 62 & 82). The benefit of this behaviour of the methods and apparatus of the present invention is that for voltage sensitive loads, the supply voltage is kept at the optimum supply to that load for best performance. In the case of electrical motors, providing optimal stable rated supply voltage, means that the motors run at their optimum efficiency.

### Preferred Circuit Embodiments

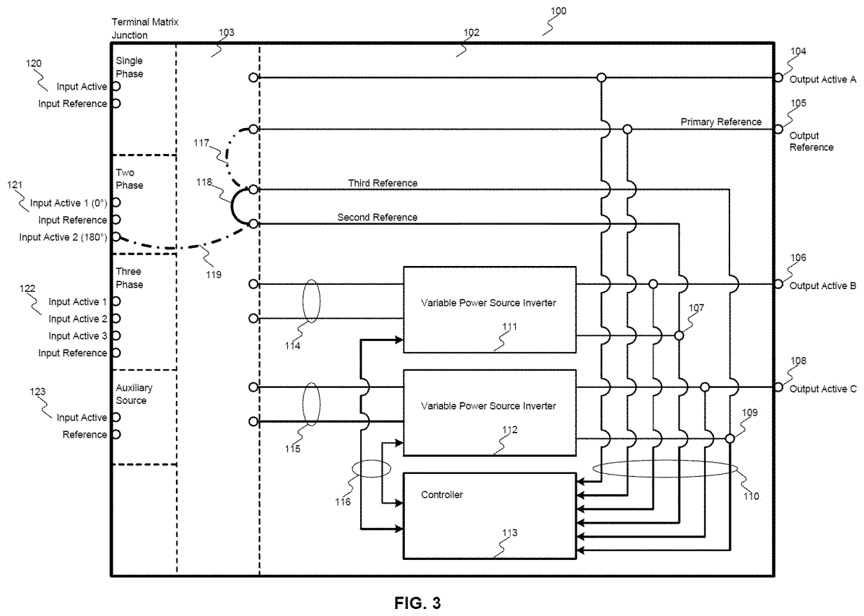

In FIG. 3, there is shown a preferred schematic diagram illustrating the preferred base topology of a preferred embodiment of a circuit or system 100 that can be utilised to produce a variable and auto regulated three phase power source, from an existing three, two or single phase power supply source, in accordance with the present invention. Although various preferred practical circuit embodiments are provided hereinafter, it should be appreciated that same are only an example of the types of circuits or systems that can be constructed in accordance with the present invention in order to produce a variable and auto regulated three phase power source from an existing three, two or single phase power supply source. A person skilled in the art will appreciate other practical hardware implementations that could also be used in order to achieve that same or similar output. Accordingly, the present invention should not be construed as limited to any one or more of the specific examples provided herein.

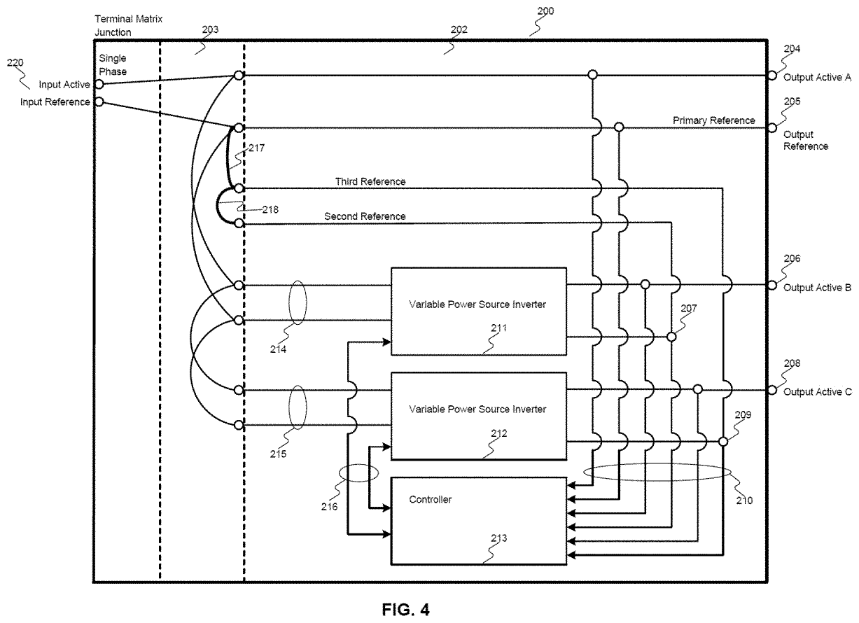

The preferred circuit or system 100 (hereinafter “system 100”) of FIG. 3 produces a Wye configuration three phase power source via subsystems 102 & 103. Each of Output Actives A, B & C (at terminals 104, 106 & 108) carry potential in reference to Output Reference 105. The Variable Power Source Inverter 111 produces AC single phase power via terminals 106 & 107. Likewise, the Variable Power Source Inverter 112 produces AC single phase power via terminals 108 & 109. The Controller 113 samples all subsystem 102 inputs and outputs via connections 110, and controls Variable Power Source Inverters 111 & 112 via bidirectional control lines 116. Whilst a separate Controller 113 is shown and described in FIG. 3 (and likewise in other Figures), it will be appreciated that instead of a separate Controller 113, each of Variable Power Source Inverters 111 & 112 could have an internal controller (not shown) that receives inputs via connections 110 (or via any other suitable connections), and which could control the Inverter (111 or 112) via internal control similar to the disclosed control lines 116. Both Variable Power Source Inverters 111 & 112 are powered by one or more power source(s) connected to lines 114 & 115, respectively, via terminals in subsystem 103 (which can also be referred to as the “Terminal Matrix Junction 103”). Power input into the Terminal Matrix Junction 103 may be by one, or a combination of more than one, of the power sources 120 (single phase), 121 (two phase), 122 (three phase) & 123 (an auxiliary source), as shown. Several configurations of possible preferred power inputs that may be utilised in accordance with the methods and apparatus of the present invention will be described hereinafter with reference to FIGS. 4 to 6 and 9 to 11. Depending on the applicable power input (120, 121, 122 and/or 123) into Terminal Matrix Junction 103, the wiring configuration within Terminal Matrix Junction 103 is either 117, 118 & 119, or a combination of them that is connected between the Output Reference (105), via the Primary Reference, and the Second Reference (107) and the Third Reference (109), and any of the Input Reference of 120, 121 or 122 and/or the Auxiliary Source Reference of 123, depending on the selected configuration. Various preferred Reference configurations will also be described hereinafter with reference to FIGS. 4 to 6 and 9 to 11.

In FIG. 4, there is shown a further preferred schematic diagram illustrating how the preferred system 100 of FIG. 3 may be utilised to produce a variable and auto regulated three phase power source, from an existing single phase power supply source, in accordance with a preferred embodiment of the present invention.

The preferred circuit or system 200 (hereinafter “system 200”) of FIG. 4 produces a Wye configuration three phase power source via subsystems 202 & 203. Subsystem 202 operates exactly as per subsystem 102, of system 100, of FIG. 3, and as such, the reference numerals within subsystem 202, of FIG. 4, are the same as that of subsystem 102, of FIG. 3, but increased by one hundred, e.g. controller 113 of subsystem 102 of FIG. 3, becomes controller 213 of subsystem 202 of FIG. 4, etc. Power input into Terminal Matrix Junction 203 is from power source 220, that is a single phase power source that has an Input Active node in reference to an Input Reference node. Power source 220 feeds Output Active A (204) and Output Reference 205, respectively. Output Reference 205 is connected to the Second and Third References (207 & 209), via bridging connections 217 & 218. This makes Output Actives B & C (206, 208) carry potential in reference to Output Reference 205. The Variable Power Source Inverters 211 & 212, are powered by the input power source 220, via connections 214 & 215. This preferred configuration of system 200 produces a Wye configuration three phase power source that has Output Actives A, B & C (204, 206 & 208), respectively referenced to the Output Reference 205 via the Primary Reference. Each of the Variable Power Source Inverters 211 & 212, produce AC power with variable voltage and phase angle displacement in reference to Output Active A (204). Thus, when, for example: Output Active A (204) presents 324V (230V RMS) @ 0°, Variable Power Source Inverter 211 produces a 324V (230V RMS) @ 120° power phasor (i.e. FIG. 2A, phasor 47), and Variable Power Source Inverter 212 produces a 324V (230V RMS) @ −120° power phasor (i.e. FIG. 2A, phasor 50); Output Active A (204) presents 259V (184V RMS) @ 0°, Variable Power Source Inverter 211 produces a 360V (255V RMS) @ 129° power phasor (i.e. FIG. 2B, phasor 67), and Variable Power Source Inverter 212 produces a 360V (255V RMS) @ −129° power phasor (i.e. FIG. 2B, phasor 70); and, Output Active A (204) presents 373V (264V RMS) @ 0°, Variable Power Source Inverter 211 produces a 304V (215V RMS) @ 113° power phasor (i.e. FIG. 2C, phasor 87), and Variable Power Source Inverter 212 produces a 304V (215V RMS) @ −113° power phasor (i.e. FIG. 2C, phasor 90).

Thus, system 200 of FIG. 4, produces three Wye connected single phase phasors (Output Actives A, B & C (204, 206 & 208)) with two of those phasors (i.e. Output Actives B & C (206 & 208)) having been constructed or produced by the Variable Power Source Inverters 211 & 212 that vary in amplitude and phase angle displacement, in reference to the voltage of Output Active A (204), in order to compensate for variations in the amplitude of Output Active A (204); whilst the Delta phasor voltages between respective Output Actives A, B or C (204, 206 or 208) are auto regulated to be kept stable by constant amplitude at 564V (400VRMS) and constant phase angle displacement as per the phasor diagrams of FIG. 2A through to FIG. 2C (i.e. 44, 49, 53), (64, 69, 73) & (84, 89, 93), respectively.

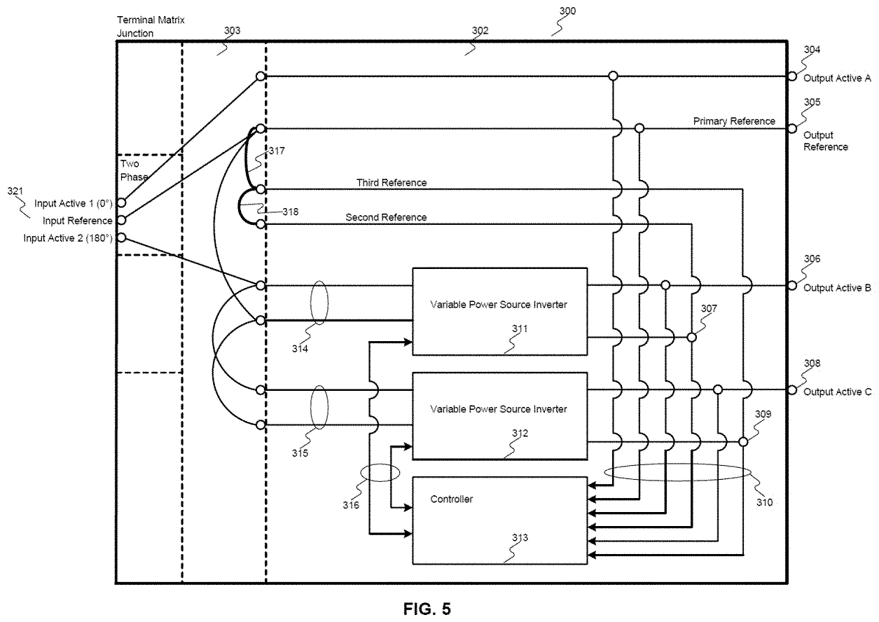

In FIG. 5, there is shown a further preferred schematic diagram illustrating how the preferred system 100 of FIG. 3 may be utilised to produce a variable and auto regulated three phase power source, from an existing two phase power supply source, in accordance with a preferred embodiment of the present invention. In FIG. 5, the reference numerals shown throughout the drawing correspond to those of FIG. 3, but are increased by two hundred, e.g. controller 113 FIG. 3, becomes controller 313 of FIG. 5, etc.

The preferred circuit or system 300 (hereinafter “system 300”) of FIG. 5 produces a Wye configuration three phase power source via subsystems 302 & 303. Preferred system 300 of FIG. 5, is similar to that of preferred system 200, of FIG. 4, with the only difference being that Terminal Matrix Junction 303 is now fed by a two phase power source 321 that has an Input Active 1 (@ 0°), an Input Reference and an Input Active 2 that has a 180° phase angle displacement to Input Active 1. This type of power supply is common in the electricity distribution industry, especially in rural areas throughout the world. Whilst a two phase supply 321 having a first active (Input Active 1) and a negative polarity second active (Input Active 2), both referencing to the same reference (Input Reference) is shown and described with reference to system 300, of FIG. 5, it will be appreciated that the present invention is not limited to such a two phase supply. That is, instead of a negative polarity second active, preferred system 300, of FIG. 5, of the present invention could be modified to operate with two actives having the same polarity referenced to a different input reference. Likewise, whilst Input Active 1 of power supply 321, of preferred system 300, of FIG. 5, is shown connected to Output Active A (304), and Input Active 2 is shown as feeding power to both of the Variable Power Source Inverters 311 & 312, via connections 314 & 315, it will be appreciated that those connections could be reconfigured such that Input Active 2 is connected to Output Active A (304), and Input Active 1 is feeding the Variable Power Source Inverters 311 & 312; or, even reconfigured such that one of the Input Actives 1 or 2 is connected to both Output Active A (304) and one of the Variable Power Source Inverters 311 or 312, and the other Input Active 1 or 2 is feeding only the other Variable Power Source Inverter 311 or 312. A skilled person will appreciate these and other modifications that may be made to preferred system 300, of FIG. 5, without departing from the spirit and scope of the present invention as herein described. Accordingly, the present invention should not be construed as limited to the specific examples provided.

Thus, system 300 of FIG. 5, also produces three Wye connected single phase phasors (Output Actives A, B & C (304, 306 & 308)) with two of those phasors (i.e. Output Actives B & C (306 & 308)) having been constructed or produced by the Variable Power Source Inverters 311 & 312 in a similar fashion to that of preferred system 200 of FIG. 4.

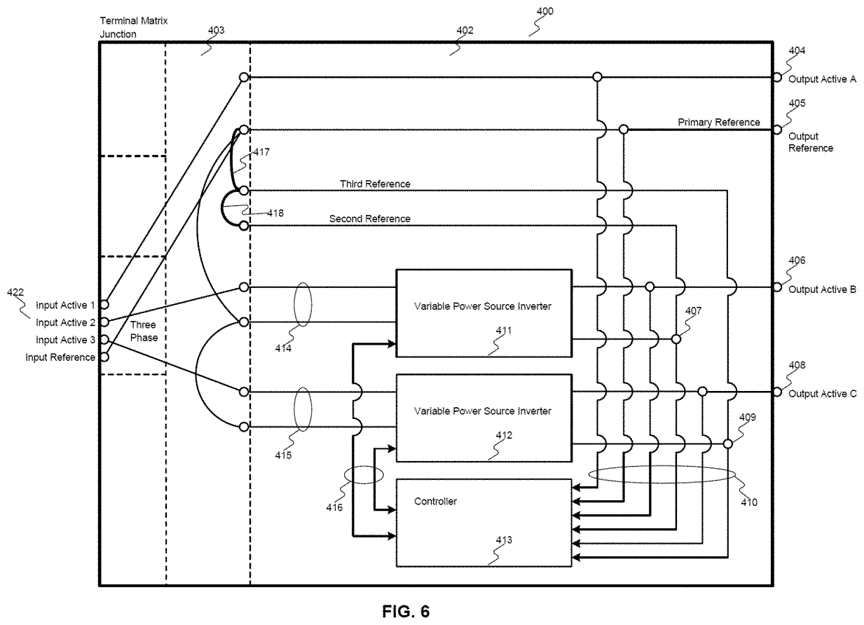

In FIG. 6, there is shown a further preferred schematic diagram illustrating how the preferred system 100 of FIG. 3 may be utilised to produce a variable and auto regulated three phase power source, from an existing three phase power supply source, in accordance with a preferred embodiment of the present invention. In FIG. 6, the reference numerals shown throughout the drawing correspond to those of FIG. 3, but are increased by three hundred, e.g. controller 113 FIG. 3, becomes controller 413 of FIG. 5, etc.

The preferred circuit or system 400 (hereinafter “system 400”) of FIG. 6 produces a Wye configuration three phase power source via subsystems 402 & 403. Preferred system 400 of FIG. 6, is similar to that of preferred systems 200 & 300, of FIGS. 4 & 5, with the only difference being that Terminal Matrix Junction 403 is now fed by a three phase power source 422 that has an Input Active 1, an Input Active 2, an Input Active 3, and an Input Reference (reference to all Input Actives 1 to 3). This type of power supply is common in the electricity distribution industry around the world. In preferred system 400: Input Active 1 is connected directly to Output Active A (404); Input Active 2 feeds Variable Power Source Inverter 411; Input Active 3 feeds Variable Power Source Inverter 412; and, Input Reference is connected to Output Reference 405. Although not shown in FIG. 6, it will be appreciated that the Input Active 1 to 3 connections within Terminal Matrix Junction 403, of system 400, could be swapped around or reconfigured to achieve the same outcome, i.e. by Input Phase rotation. A skilled person will appreciate such modifications of connections within Terminal Matrix Junction 403, of system 400, and as such, the present invention should not be construed as limited to the specific examples provided.

Thus, system 400 of FIG. 6, also produces three Wye connected single phase phasors (Output Actives A, B & C (404, 406 & 408)) with two of those phasors (i.e. Output Actives B & C (406 & 408)) having been constructed or produced by the Variable Power Source Inverters 411 & 412 in a similar fashion to that of preferred systems 200 & 300 of FIGS. 4 & 5.

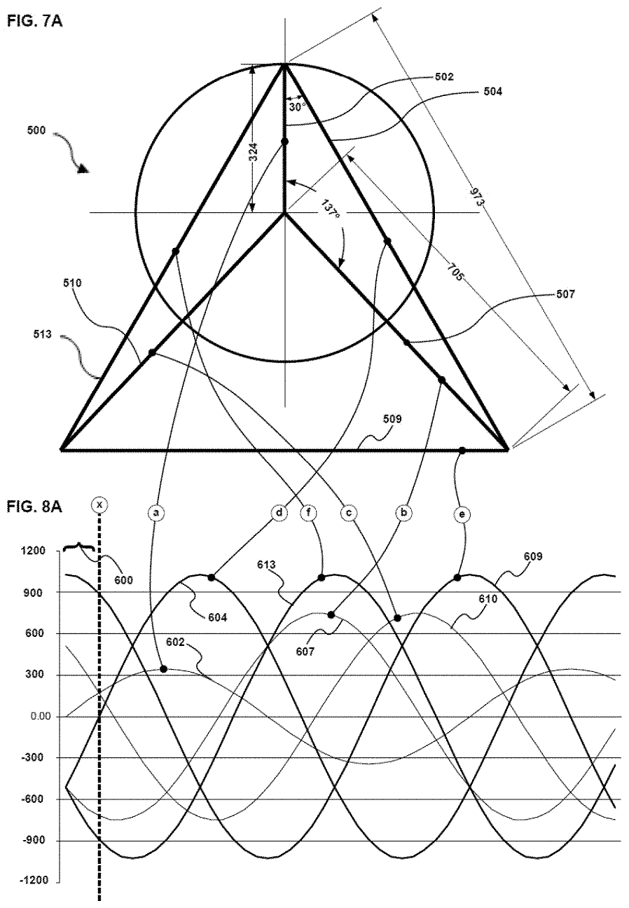

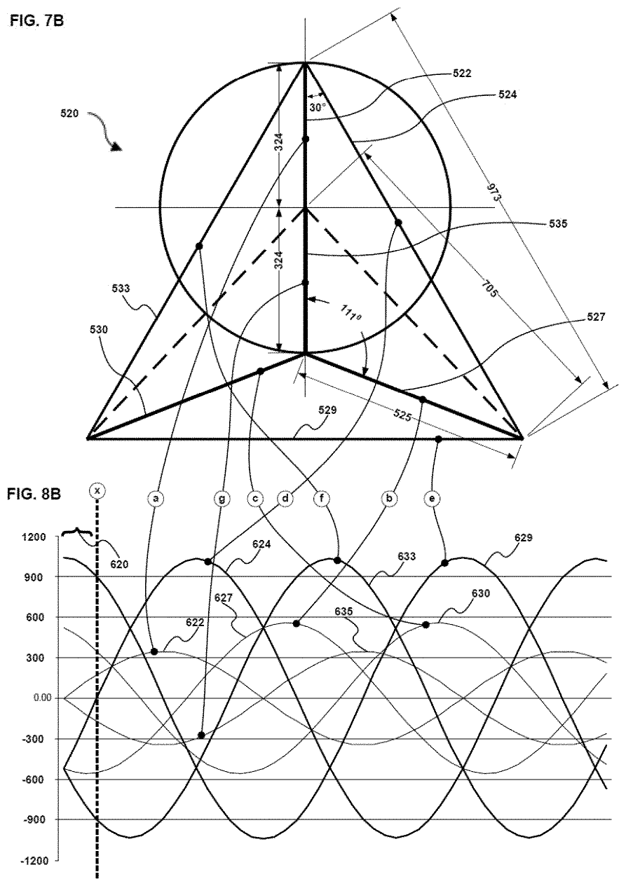

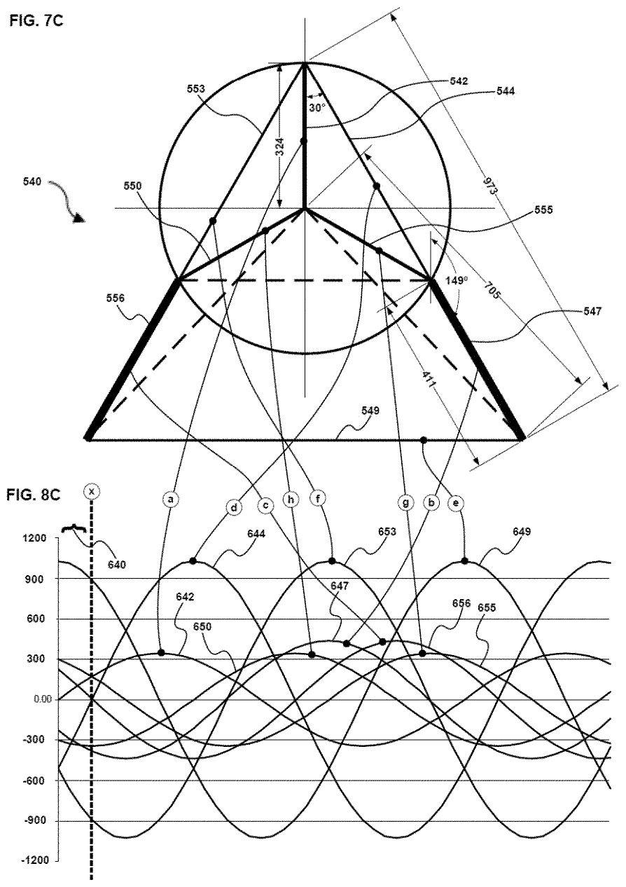

### FIGS. 7A to 8C—Regulated Delta at Non-Code Standard Output Voltage:

A further important aspect of the present invention will now be described with reference to FIGS. 7A to 8C (in particular). Whilst FIGS. 1A to 6 were hereinbefore used to describe a first important aspect of the present invention, which can be conveniently termed a “Code Standard Regulated Output” mode of operation of the invention, some of FIGS. 1A to 6 will now be referred to hereinafter in conjunction with FIGS. 7A to 11, in order to describe a further important aspect of the present invention which can be conveniently termed a “Non-Code Standard Regulated Output” mode of operation of the present invention.

FIGS. 7A to 7C show further various preferred phasor diagrams which illustrate how a variable and auto regulated three phase power source, having a non-Code standard output voltage, may be produced in accordance with the preferred “Non-Code Standard Regulated Output” mode of operation of the present invention. Whilst, FIGS. 8A to 8C show preferred time based waveform diagrams, each of which illustrate the amplitude and phase angle displacements of the corresponding phasors of the preferred phasor diagrams of FIGS. 7A to 7C, respectively. The phasors in the preferred phasor diagrams of FIGS. 7A to 7C are linked to the time based waveforms of FIGS. 8A to 8C with links numbered (a) to (f), (a) to (g), and (a) to (h), where applicable.

In FIG. 7A, there is shown a three phase phasor diagram 500 with unequal Wye phasors' amplitudes of: 502 @ 324V (or 230V RMS); 507 @ 705V (or 500V RMS); and, 510 @ 705V (or 500V RMS) (not shown); which produces equal Delta phasors' amplitudes of: 504 @ 973V (or 690V RMS); 509 @ 973V (or 690V RMS); and, 513 @ 973V (or 690V RMS). While phasor diagram 40, of FIG. 2A, discloses a Delta/Wye ratio of SQRT3 (564V/324V—FIG. 2A, phasors 44 & 42), the phasor diagram 500, of FIG. 7A, discloses a Delta/Wye ratio of 3 (973V/324V—FIG. 7A, phasors 504 & 502). This preferred Delta/Wye ratio can be achieved by any one of the preferred circuits or systems 200, 300 or 400, of FIGS. 4 to 6, or the preferred circuit or system 800 of FIG. 10, which will be described in further detail below, where the Variable Power Source Inverter (211, 311, 411 or 811) that produces power to Output Active B (206, 306, 406 or 806) in those Figures, produces power at a voltage level of 705V (or 500V RMS), i.e. phasor 507 in FIG. 7A, and the Variable Power Source Inverter (212, 312, 412 or 812) that produces power to Output Active C (208, 308, 408 or 808) in the same Figures, produces power at a voltage level of 705V (or 500V RMS) as well, i.e. phasor 510 in FIG. 7A. Whilst phasor 507, of phasor diagram 500, of FIG. 7A, is produced at a phase angle displacement of 137° in reference to phasor 502, phasor 510 is produced at a phase angle displacement of −137° (not shown) in reference to phasor 502.

In FIG. 8A, there is shown a time based waveform diagram which illustrates the amplitude and phase angle displacements of the corresponding phasors shown in the preferred phasor diagram 500 of FIG. 7A. Here, any of the Output Actives A (204, 304, 404 or 804) of preferred circuits or systems 200, 300, 400 or 800, of FIGS. 4 to 6 & 10, that could be represented by phasor 502 of FIG. 7A, are presented as a time base waveform shape 602, in FIG. 8A, and are linked to FIG. 7A by way of Link (a). The other waveforms shown in FIG. 8A represent the Delta/Wye phasors, respectively, with Links (b), (c), (d), (e) & (f). For example, in FIG. 8A: FIG. 7A, phasor 502 is linked to FIG. 8A, waveform 602 via Link (a); FIG. 7A, phasor 507 is linked to FIG. 8A, waveform 607 via Link (b); FIG. 7A, phasor 510 is linked to FIG. 8A, waveform 610 via Link (c); FIG. 7A, phasor 504 is linked to FIG. 8A, waveform 604 via Link (d); FIG. 7A, phasor 509 is linked to FIG. 8A, waveform 609 via Link (e); and, FIG. 7A, phasor 513 is linked to FIG. 8A, waveform 613 via Link (f). Item 600 shown in the waveform diagram of FIG. 8A, illustrates a gap between the point of zero crossing of waveform 602, to where waveform 604 has a zero crossing. This is also illustrated by the vertical dotted line (x). The gap (600) in time, equals to a 30° angle displacement, which is a standard angle displacement when showing, on the same time base chart, the standard relationship between the Delta and Wye configuration of the same system. This can be represented by the symbol of DYN11, which means a three phase standard transformer winding with primary Delta (three wire) and a secondary Wye (four wire) configuration, with the 11 referring to 11 o′clock, which means a 30° angle displacement.

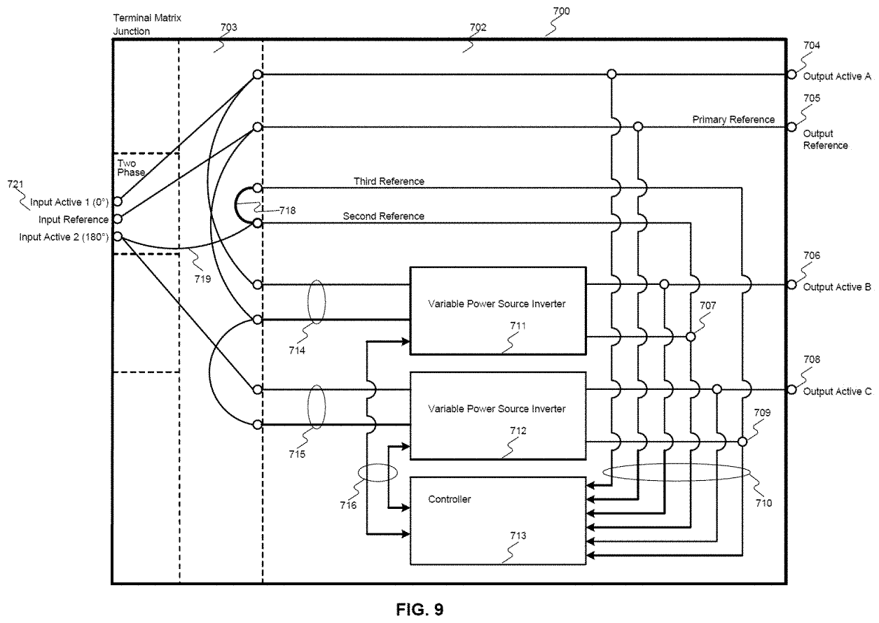

In FIG. 7B, there is shown a three phase phasor diagram 520 with unequal Wye phasors' amplitudes of: 522 @ 324V (or 230V RMS); 527 @ 525 V (or 369V RMS); and, 530 @ 525V (or 369V RMS) (not shown); which produces equal Delta phasors' amplitudes of: 524 @ 973V (or 690V RMS); 529 @ 973V (or 690V RMS); and, 533 @ 973V (or 690V RMS). While phasor diagram 40, of FIG. 2A, discloses a Delta/Wye ratio of SQRT3 (564V/324V—FIG. 2A, phasors 44 & 42), the phasor diagram 520, of FIG. 7B, discloses a Delta/Wye ratio of 3 (973V/324V—FIG. 7B, phasors 524 & 522). This preferred Delta/Wye ration can be achieved via the preferred circuit or system 700, shown in FIG. 9, which will be described in further detail below, where the Variable Power Source Inverter 711 that produces power to Output Active B (706) in that Figure, produces power at a voltage level of 525V (or 369V RMS), i.e. phasor 527 in FIG. 7B, and the Variable Power Source Inverter 712 that produces power to Output Active C (708) in the same Figure, produces power at a voltage level of 525V (or 369V RMS) as well, i.e. phasor 530 in FIG. 7B. Whilst phasor 527, of phasor diagram 520, of FIG. 7B, is produced at a phase angle displacement of 111° in reference to phasor 522, phasor 530 is produced at a phase angle displacement of −111° (not shown) in reference to phasor 522. FIG. 7B also shows a phasor 535 that represents Input Active 2 (180°), of two phase power supply 721, of system 700, of FIG. 9.

In FIG. 8B, there is shown a time based waveform diagram which illustrates the amplitude and phase angle displacements of the corresponding phasors shown in the preferred phasor diagram of FIG. 7B. Here, Output Active A (704) of preferred circuit of system 700, of FIG. 9, that could be represented by phasor 522 of FIG. 7B, is presented as a time base waveform shape 622, in FIG. 8B, and is linked to FIG. 7B by way of Link (a). The other waveforms shown in FIG. 8B represent the Delta/Wye phasors, respectively, with Links (b), (c), (d), (e), (f) & (g). For example, in FIG. 8B: FIG. 7B, phasor 522 is linked to FIG. 8B, waveform 622 via Link (a); FIG. 7B, phasor 527 is linked to FIG. 8B, waveform 627 via Link (b); FIG. 7B, phasor 530 is linked to FIG. 8B, waveform 630 via Link (c); FIG. 7B, phasor 524 is linked to FIG. 8B, waveform 624 via Link (d); FIG. 7B, phasor 529 is linked to FIG. 8B, waveform 629 via Link (e); FIG. 7B, phasor 533 is linked to FIG. 8B, waveform 633 via Link (f); and, FIG. 7B, phasor 535 is linked to FIG. 8B, waveform 635 via Link (g). Item 620 shown in the waveform diagram of FIG. 8B, illustrates a gap between the point of zero crossing of waveform 622, to where waveform 624 has a zero crossing. This is also illustrated by the vertical dotted line (x). The gap (620) in time, equals to a 30° angle displacement, which is a standard angle displacement when showing, on the same time base chart, the standard relationship between the Delta and Wye configuration of the same system. This can be represented by the symbol of DYN11, which means a three phase standard transformer winding with primary Delta (three wire) and a secondary Wye (four wire) configuration, with the 11 referring to 11 o′clock, which means a 30° angle displacement.

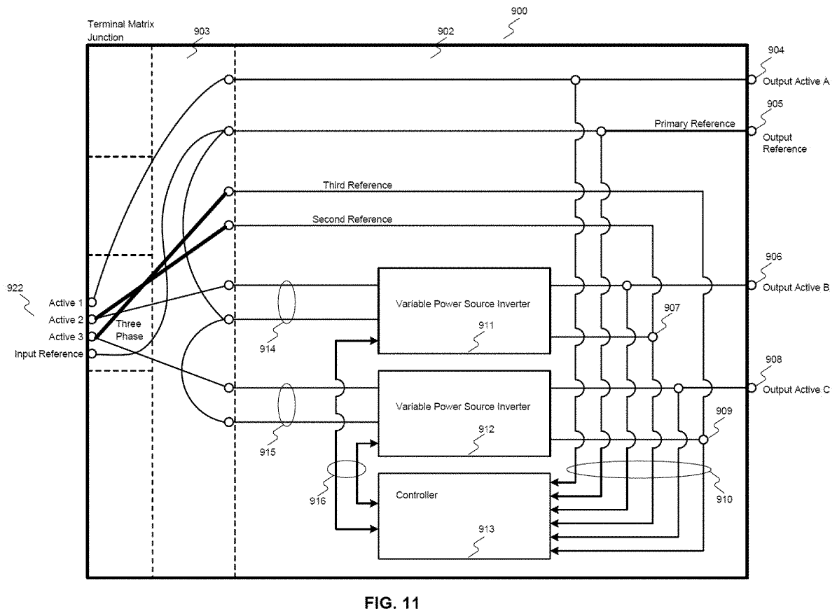

In FIG. 7C, there is shown a three phase phasor diagram 540 with unequal Wye phasors' amplitudes of: 542 @ 324V (or 230V RMS); 555 @ 324V (or 230V RMS) (not shown); 550 @ 324V (or 230V RMS) (not shown); 547 @ 411V (or 289V RMS); and, 556 @ 411V (or 289V RMS) (not shown); which produces equal Delta phasors' amplitudes of: 544 @ 973V (or 690V RMS); 549 @ 973V (or 690V RMS); and, 553 @ 973V (or 690V RMS). While phasor diagram 40, of FIG. 2A, discloses a Delta/Wye ratio of SQRT3 (564V/324V—FIG. 2A, phasors 44 & 42), the phasor diagram 540, of FIG. 7C, discloses a Delta/Wye ratio of 3 (973V/324V—FIG. 7C, phasors 544 & 542). This preferred Delta/Wye ratio can be achieved via the preferred circuit or system 900, shown in FIG. 11, which will be described in further detail below, where the Variable Power Source Inverter 911 that produces power to Output Active B (906) in that Figure, produces power at a voltage level of 411V (or 289V RMS), i.e. phasor 547 in FIG. 7C, and the Variable Power Source Inverter 912 that produces power to Output Active C (908) in the same Figure, produces power at a voltage level of 411V (or 289V RMS) as well, i.e. phasor 556 in FIG. 7C. Whilst phasor 547, of phasor diagram 540, of FIG. 7C, is produced at a phase angle displacement of 149° in reference to phasor 542, phasor 556 is produced at a phase angle displacement of −149° (not shown) in reference to phasor 542. FIG. 7C also shows a phasor 555 that represents Input Active 2 (120°) of three phase power supply 922, of system 900, of FIG. 11, and a phasor 550 that represents Input Active 3 (−120°) of three phase power supply 922, of system 900, of FIG. 11.

In FIG. 8C, there is shown a time based waveform diagram which illustrates the amplitude and phase angle displacements of the corresponding phasors shown in the preferred phasor diagram of FIG. 7C. Here, Output Active A (904) of preferred circuit of system 900, of FIG. 11, that could be represented by phasor 542 of FIG. 7C, is presented as a time base waveform shape 642, in FIG. 8C, and is linked to FIG. 7C by way of Link (a). The other waveforms shown in FIG. 8C represent the Delta/Wye phasors, respectively, with Links (b), (c), (d), (e), (f), (g) & (h). For example, in FIG. 8C: FIG. 7C, phasor 542 is linked to FIG. 8C, waveform 642 via Link (a); FIG. 7C, phasor 547 is linked to FIG. 8C, waveform 647 via Link (b); FIG. 7C, phasor 556 is linked to FIG. 8C, waveform 656 via Link (c); FIG. 7C, phasor 544 is linked to FIG. 8C, waveform 644 via Link (d); FIG. 7C, phasor 549 is linked to FIG. 8C, waveform 649 via Link (e); FIG. 7C, phasor 553 is linked to FIG. 8C, waveform 653 via link (f); FIG. 7C, phasor 555 is linked to FIG. 8C, waveform 655 via Link (g); and, FIG. 7C, phasor 550 is linked to FIG. 8C, waveform 650 via Link (h). Item 640 shown in the waveform diagram of FIG. 8C, illustrates a gap between the point of zero crossing of waveform 642, to where waveform 644 has a zero crossing. This is also illustrated by the vertical dotted line (x). The gap (640) in time, equals to a 30° angle displacement, which is a standard angle displacement when showing, on the same time base chart, the standard relationship between the Delta and Wye configuration of the same system. This can be represented by the symbol of DYN11, which means a three phase standard transformer winding with primary Delta (three wire) and a secondary Wye (four wire) configuration, with the 11 referring to 11 o′clock, which means a 30° angle displacement.

### Further Preferred Circuit Embodiments

As already briefly outlined above, in FIG. 9, there is shown a preferred schematic diagram illustrating how a variable and auto regulated three phase power source, having a non-Code standard output voltage, may be produced, from an existing two phase power supply source, in accordance with a further preferred aspect of the present invention, i.e. the aforesaid “Non-Code Standard Regulated Output” mode of operation of the present invention. In FIG. 9, the reference numerals shown throughout the drawing correspond to those of FIG. 3, but are increased by six hundred, e.g. controller 113 FIG. 3, becomes controller 713 of FIG. 9, etc.

The preferred circuit or system 700 (hereinafter “system 700”) of FIG. 9, is similar to preferred system 300, of FIG. 5, with one significant difference. That is, the Variable Power Source Inverters' 711 & 712 outputs 707 & 709, respectively, are connected (via connections 718 & 719) to a potential carrying node, that is Input Active 2 (180°) of input two phase power supply 721. In this arrangement, the Variable Power Source Inverters' 711 & 712, are producing power per FIG. 7B, i.e. phasors 527 & 530, respectively, at amplitude 525V (or 389V RMS) with phase angle displacement of 111° and −111°, respectively. The geometric summation of phasors 535 and 527 may be expressed by Formula 4, as follows:

324(sin wt+180°)+525(sin wt+111°)=705 (sin wt+137°) Formula 4

This result is similar to FIG. 7A, phasor 507, that is a phasor with amplitude of 705V (or 500V RMS) and phase angle displacement of 137° in reference to the Output Active A in any one of the drawings provided herein. Similarly the geometric summation of phasors 535 and 530 may be expressed in Formula 5, as follows:

324(sin wt+180°)+525(sin wt−111°)=705(sin wt−137°) Formula 5

This result is similar to FIG. 7A, phasor 510, that is a phasor with amplitude of 705V (500V RMS) and phase angle displacement of −137° in reference to the Output Active A in any one of the drawings provided herein.

Thus, preferred system 700, of FIG. 9, produces a Delta phasor configuration similar to phasor diagram 500 of FIG. 7A, however by means of the Variable Power Source Inverters 711 & 712, that produce power at only 525V (or 369V RMS), instead of producing power at 705V (500V RMS). This means that where input power (721) into Terminal Matrix Junction 703 is of the nature of one Input Active and another Input Active with a phase angle displacement of 180°, in reference to the first Input Active, then the Variable Power Source Inverters 711 & 712, can be of a smaller capacity than any of the respective Inverters disclosed in FIGS. 4, 5, 6 & 10, for the purpose of producing power at voltages higher than the natural or Code standard Delta/Wye ratio.

Again, as already briefly outlined above, in FIG. 10, there is shown a preferred schematic diagram illustrating how a variable and auto regulated three phase power source, having a non-Code standard output voltage, from a combination of an existing single phase power supply source and an auxiliary power supply source, in accordance with a further preferred aspect of the present invention, i.e. again, the aforesaid “Non-Code Standard Regulated Output” mode of operation of the present invention. In FIG. 10, the reference numerals shown throughout the drawing correspond to those of FIG. 3, but are increased by seven hundred, e.g. controller 113 FIG. 3, becomes controller 813 of FIG. 10, etc.

The preferred circuit or system 800 (hereinafter “system 800”) of FIG. 10, is similar to preferred system 300, of FIG. 5, with one significant difference. That is, the power input into Terminal Matrix Junction 803 is made of a single phase Input Active and Input Reference (822), which powers Output Active A (804), and Variable Power Source Inventor 811 via connections 814; whilst an auxiliary power source (823) having an input power comprising an Active and Reference is used to power Variable Power Source Inverter 812, via connections 815. Although not shown in FIG. 10, it will be appreciated that the configuration of input single phase power supply source (822) and auxiliary power source (823) could be swapped or reconfigured, as desired, in order to achieve the same outcome. A skilled person will appreciate such a modification of preferred system 800, of FIG. 10, and as such, the present invention should not be construed as limited to the specific example provided.

Yet again, as already briefly outlined above, in FIG. 11 there is shown a schematic diagram illustrating how a variable and auto regulated three phase power source, having a non-Code standard output voltage, may be produced, from an existing thee phase power supply source, in accordance with a further preferred aspect of the present invention, i.e. yet again, the aforesaid “Non-Code Standard Regulated Output” mode of operation of the present invention. In FIG. 11, the reference numerals shown throughout the drawing correspond to those of FIG. 3, but are increased by eight hundred, e.g. controller 113 FIG. 3, becomes controller 913 of FIG. 11, etc.

The preferred circuit or system 900 (hereinafter “system 900”) of FIG. 11, includes subsystems 902 and 903 (i.e. Terminal Matrix Junction 903). In this preferred embodiment, subsystem 902 of system 900, of FIG. 11, operates in a similar fashion to that of subsystem 702 of preferred system 700, of FIG. 9, whilst Terminal Matrix Junction 903 of system 900, of FIG. 11, operates in a similar fashion to that of subsystem 403 of preferred system 400, of FIG. 6. The three phase power input (922) provides power to Output Active A (904), Variable Power Source Inverter (911), via connection 914, and to Variable Power Source Inverter 912, via connections 915. However, in this instance, the Variable Power Source Inverters' outputs 907 & 909, are now connected to a potential carrying nodes Input Active 2 and Input Active 3, respectively, of three phase power supply source 922. This configuration produces a three phase Delta output with a Line to Line voltage higher than the three phase power Input Actives (1 to 3) by means of only two relatively smaller capacity Inverters (911 & 912). An example of the operation of system 900, of FIG. 11, is provided by way of the phasor diagram 540 of FIG. 7C, and the corresponding waveform diagram of FIG. 8C.

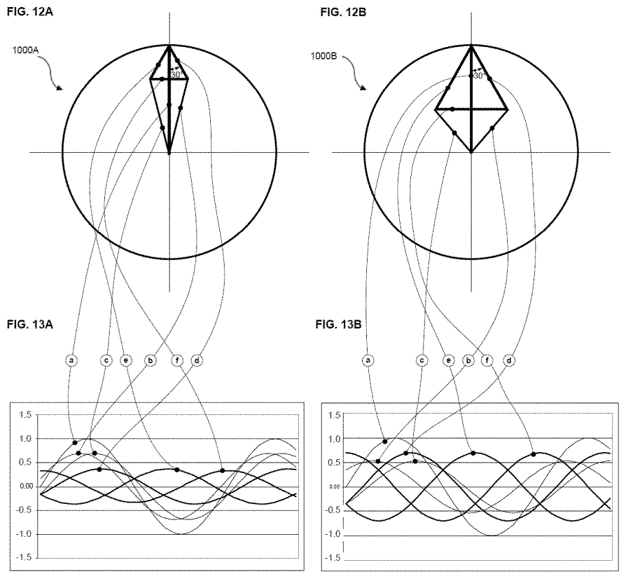

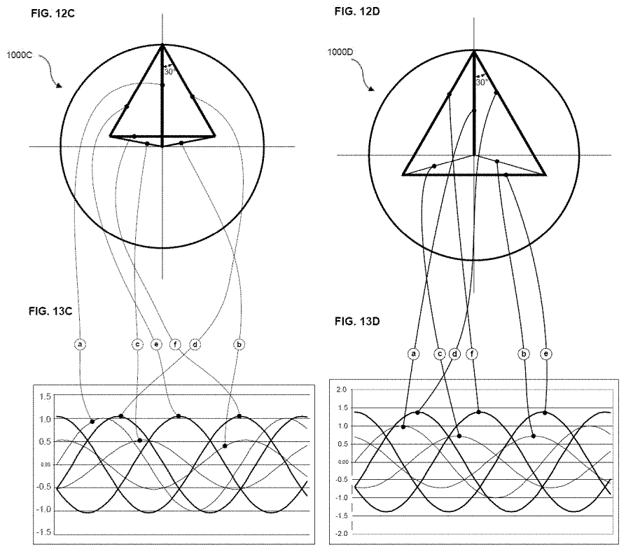

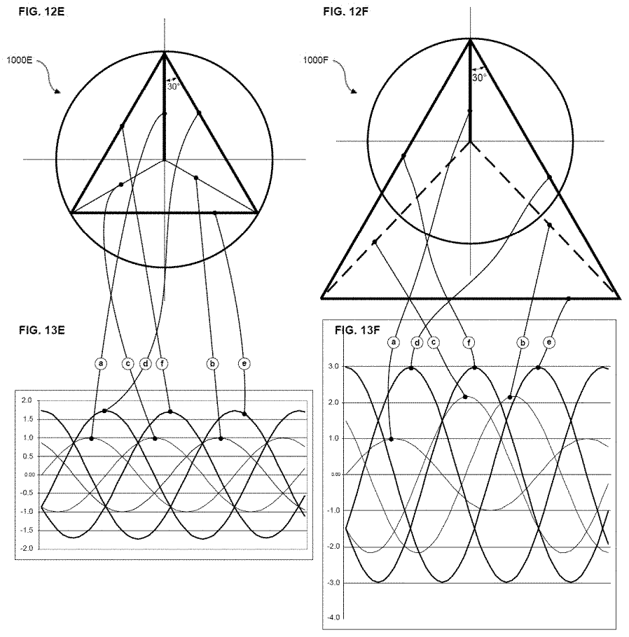

### FIGS. 12A to 13F—Ramping Up/Down Regulated Output Voltage:

A further important aspect of the present invention will now be described with reference to FIGS. 12A to 13F (in particular). Whilst FIGS. 1A to 6 were hereinbefore generally used to describe a first important aspect of the present invention, i.e. the aforesaid “Code Standard Regulated Output” mode of operation of the invention, and Figs, 7A to 11 were hereinbefore generally used to describe a further or second important aspect of the present invention, i.e. the aforesaid “Non-Code Standard Regulated Output” mode of operation of the invention, some of FIGS. 1A to 11 will now be referred to hereinafter in conjunction with FIGS. 12A to 13F, in order to describe yet a further or third important aspect of the present invention which can be conveniently termed a “Ramping Up/Down Regulated Output” mode of operation of the present invention.

FIGS. 12A to 12F show further various preferred phasor diagrams which illustrate how a variable and auto regulated three phase power source, having a ramping up/down mode of operation, may be produced in accordance with the preferred “Ramping Up/Down Regulated Output” mode of operation of the present invention. Whilst, FIGS. 13A to 13F show preferred time based waveform diagrams, each of which illustrate the amplitude and phase angle displacements of the corresponding phasors of the preferred phasor diagrams of FIGS. 12A to 12F, respectively. The phasors in the preferred phasor diagrams of FIGS. 12A to 12F are linked to the time based waveforms of FIGS. 13A to 13F with links numbered (a) to (f). Whilst FIGS. 12A to 13F are herein generally used to described the preferred “Ramping Up/Down Regulated Output” mode of operation of the present invention, it should be readily appreciated that those Figures also illustrate the various non-Code standard stable output voltages that can be achieved in accordance with to the aforesaid preferred “Non-Code Standard Regulated Output” mode of operation of the present invention described above.

Preferred phasor diagrams 1000A to 1000F, of FIGS. 12A to 12F, are essentially a series of Phasor snap shots of the Output Actives (A, B & C) voltages and angle displacement of any of one of the preferred circuits or systems 100 to 400 & 700 to 900, of FIGS. 3 to 6 & 9 to 11, respectively. Likewise, preferred time based waveform diagrams of FIGS. 13A to 13F, are essentially a series of time based waveform shape snap shots of the Output Actives (A, B & C) voltages and angle displacement of any of one of the preferred circuits or systems 100 to 400 & 700 to 900, of FIGS. 3 to 6 & 9 to 11, respectively. In addition to FIGS. 12A to 13F illustrating the preferred “Ramping Up/Down Regulated Output” mode of operation of the present invention, a number of the other important aspects of the present invention as hereinbefore described are apparent from these Figures.

### Variable Set Auto Regulated Three Phase Power Source:

The variable and auto regulated three phase power source produced in accordance with any of one of the preferred circuits or systems 100 to 400 & 700 to 900, of FIGS. 3 to 6 & 9 to 11, can be configured to enable an operator (not shown) to select any desired Delta three phase voltage, and thus, can be utilised to provide varying regulated and stable Delta three phase voltages upon request. The series of Phasor snap shots 1000A to 1000F, and corresponding time based waveform shapes, shown in FIGS. 12A to 13F, illustrate various voltage output settings that all produce constant Delta Voltages in accordance with the methods and apparatus of the present invention in order to cater for an operators specific requirements. That is, any desired stable auto regulated Delta voltage may be obtained by way of Controller (113 to 413 & 713 to 913) that controls the Variable Power Source Inverters' (111 to 411 & 711 to 911, and 112 to 412 & 712 to 912) output amplitude and phase angle displacement in reference to the measured Output Active A (104 to 404 & 704 to 904) in any of preferred circuits or systems 100 to 400 & 700 to 900, of FIGS. 3 to 6 & 9 to 11, of the present invention. Real-time auto regulation in accordance with the present invention is also demonstrated by way of FIGS. 2A to 2C, wherein the Delta voltage configuration is kept stable regardless of the variations of the Output Active A (104 to 404, of FIGS. 3 to 6).

### Variable Auto Ramp Auto Regulated Three Phase Power Source:

The variable and auto regulated three phase power source produced in accordance with any of one of the preferred circuits or systems 100 to 400 & 700 to 900, of FIGS. 3 to 6 & 9 to 11, can also be configured to automatically ramp up or ramp down the three phase output voltage to suit any Delta voltage set by an operator (again, not shown), such that the power applied to a load will ramp up/down from one set point to another, as desired. The series of Phase snap shots 1000A to 1000F, and corresponding time based waveform shapes, shown in FIGS. 12A to 13F, illustrate various voltage output settings that all produce variable Delta Voltages in accordance with the methods and apparatus of the present invention in order to cater for an operators specific Delta voltage range requirements. That is, any desired stable auto regulated Delta voltage may be obtained by way of Controller (113 to 413 & 713 to 913) that controls the Variable Power Source Inverters' (111 to 411 & 711 to 911, and 112 to 412 & 712 to 912) output amplitude and phase angle displacement in reference to the measured Output Active (104 to 404 & 704 to 904) in any of preferred circuits or systems 100 to 400 & 700 to 900, of FIGS. 3 to 6 & 9 to 11, of the present invention. Real-time auto regulation in accordance with the present invention is again also demonstrated by way of FIGS. 2A to 2C, wherein the Delta voltage configuration is kept stable regardless of the variations of the Output Active A. (104 to 404, of FIGS. 3 to 6).

The present invention therefore provides new and useful methods and apparatus for producing a variable and auto regulated three phase power source from an existing three, two or single phase power supply source. Variability and regulation are achieved by controlling two of the three phase nodes/phasors by their amplitude and phase angle displacement. The combination of the two independent variable power source inverters, with an incoming unregulated source (single, two, or three phase), produces a variable three phase power source in a Wye configuration, that achieves a variable stable (constant) regulated Delta configuration three phase power source output. While each Wye phase leg, i.e. each Output Active, is referenced to a reference point, which varies depending on operational conditions, the three phase Delta legs, i.e. Active to Active, remain stable at the set (predetermined) Delta voltage at all times.

As will be readily apparent from the detailed description of the drawings provided hereinbefore, the Wye configuration three phase power source comprises one single phase power output that is connected directly to a single phase input, that may be unregulated, and two other single phase outputs from controlled variable power source inverters. Each of the variable power source inverters output phases is referenced to the incoming phase in order to measure its amplitude, and maintain a stable phase to phase voltage level by controlling each of the inverter's voltage level and phase angle displacement in reference to the first phase output. This maintains a stable three phase Delta power source output for any (within technical limits) voltage or phase angle displacement shift in the input supply.

Several important modes of operation of the disclosed methods and apparatus of the present invention are disclosed herein, including the aforesaid: “Code Standard Regulated Output” mode of operation, wherein a desired stable (Delta configuration) output Code standard voltage may be set, and kept regulated to the desired output for a wide dynamic range of input voltage, e.g. for a Code standard voltage input of 230V RMS, with variations according to the aforesaid Code (+10%/6%, or +14%/−10%), the Delta three phase output can be maintained at 400V RMS with very low variation coefficient; “Non-Code Standard Regulated Output” mode of operation, wherein a desired stable (Delta configuration) output non-Code standard voltage may be set, and kept regulated to the desired output for a wide dynamic range of input voltage—wherein the desired output voltage can be lower than the Code standard input voltage (down to 0V), or higher than the Code standard input voltage (to a limit)—e.g. for a Code standard voltage input of 230V RMS, with variations according to the aforesaid Code (+10%/−6%, or +14%/−10%), the Delta three phase output can be maintained at, e.g.: 10V RMS, 20V RMS, . . . , 208V RMS, . . . , 380V RMS, 400V RMS, . . . , 690V RMS, and so on, with very low variation coefficient; and, “Ramping Up/Down Regulated Output” mode of operation wherein an initial output voltage may be set, a desired final (stable) Delta configuration output voltage may be set, and a ramping up time may be set, such that when required, the output voltage starts to ramp up from the initial to the final setting for the duration set as the ramp up time—the output voltage being maintained and regulated to the desired output for a wide dynamic range of input voltages—with the same operation being possible for selected ramping down parameters, and the ramp up/down mode being delivered in a smooth real-time manner, or in set steps, if desired. Whilst certain preferred modes of operation are described herein, it will be appreciated that many other modes of operation of can be achieved by virtue of the methods and apparatus of the present invention. Similarly, whilst certain preferred modes of operation are described generally in isolation, it will be readily appreciated that one or more of those, or other, modes of operation can be used in conjunction with one another, e.g. the preferred “Ramping Up/Down Regulated Output” mode of operation could readily be applied/used in conjunction with either of the preferred “Code Standard Regulated Output” or “Non-Code Standard Regulated Output” modes of operation of the present invention as hereinbefore described. A skilled person will appreciate these and other possible modes of operation of the methods and apparatus of the present invention, and combinations of the uses therefor, and as such, the present invention should not be construed as limited to the specific preferred embodiments provided herein.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the attached claims. Various modifications and equivalent arrangements are intended to be included within the spirit and scope of the invention. Therefore, the specific embodiments are to be understood to be illustrative of the many ways in which the principles of the present invention may be practiced.

Where the terms “comprise”, “comprises”, “comprised” or “comprising” are used in this specification, they are to be interpreted as specifying the presence of the stated features, integers, steps or components referred to, but not to preclude the presence or addition of one or more other features, integers, steps, components to be grouped therewith.

1. A method for producing a variable and auto regulated three phase power source from an existing three, two or single phase power supply source which includes at least one input active with an input reference, wherein said three phase power source is a three phase Wye having three output actives and an output reference, and said input reference is common to said output reference, said method including the steps of:
using said at least one input active as a first output active of said three phase power source; and,
producing a second and third variable output active of said three phase power source using at least one first variable power source inverter with variable amplitude and variable phase angle displacement which produces an output of 0° to 360° variable angle displacement with reference to said first output active, and at a variable amplitude with reference to said output reference, and at least one second variable power source inverter with variable amplitude and variable phase angle displacement which produces an output at a 0° to 360° variable angle displacement with reference to said first output active, and at a variable amplitude with reference to said output reference.

2. The method as claimed in claim 1, wherein said at least one first variable power source inverter and/or said at least one second variable power source inverter are powered by said at least one input active, or actives, of said existing three, two or single phase power supply source and/or an auxiliary power supply source.

3. The method as claimed in claim 1, further including the steps of: monitoring the amplitude and phase angle displacement of said first output active, and second and third output actives with reference to said first output active, and adjusting the output of said at least one first variable power source inverter and said at least one second variable power source inverter so that the amplitude and phase angle of said second and third output actives substantially regulates the first and second variable power source inverters to produce variable and regulated first to third three phase output actives.

4. The method as claimed in claim 1, wherein said existing three, two or single phase power supply source is selected from the group consisting of: a single phase supply source; a dual phase supply source, a three phase supply source; a single, dual or three phase electricity distribution supply source; an auxiliary local or remote generator(s), wind, solar, wave, chemical or mechanical supply source(s); or, any suitable combination thereof.

5. The method as claimed in claim 4, wherein said auxiliary local or remote power supply source is selected from the group consisting of: a single phase supply source; a dual or three phase supply source; a single, dual or three phase electricity distribution supply source; or, any suitable combination thereof.

6. An apparatus for producing a variable and auto regulated three phase power source from an existing three, two or single phase power supply source which includes at least one input active with an input reference, wherein said three phase power source is a three phase Wye having three output actives and an output reference, and said input reference is common to said output reference, said apparatus including:
terminal means for connecting said at least one input active to said apparatus to be used as a first output active of said three phase power source; and,
phase generation means for producing a second and third variable output active of said three phase power supply source, wherein said phase generation means includes at least one first variable power source inverter with variable amplitude and variable phase angle displacement which produces an output of 0° to 360° variable angle displacement with reference to said first output active, and at a variable amplitude with reference to said output reference, and at least one second variable power source inverter with variable amplitude and variable phase angle displacement which produces an output at a 0° to 360° variable angle displacement with reference to said first output active, and at a variable amplitude with reference to said output reference.

7. The apparatus as claimed in claim 6, wherein said at least one first variable power source inverter and/or said at least one second variable power source inverter are powered by said at least one input active, or actives, of said existing three, two or single phase power supply source and/or an auxiliary power supply source.

8. The apparatus as claimed in claim 6, wherein said phase generation means further includes monitoring means for monitoring the amplitude and phase angle displacement of said first output active and said second and third output actives with reference to said first output active, and for adjusting the output of said at least one first variable power source inverter and said at least one second variable power source inverter so that the amplitude and phase angle of said second and third output actives substantially regulates the first and second variable power source inverters to produce variable and regulated first to third three phase output actives.

9. The apparatus as claimed in claim 6, wherein said existing three, two or single phase power supply source is selected from the group consisting of: a single phase supply source; a dual phase supply source; a three phase supply source; a single, dual or three phase electricity distribution supply source; an auxiliary local or remote generator(s), wind, solar, wave, chemical or mechanical supply source(s); or, any suitable combination thereof.

10. The apparatus as claimed in claim 9, wherein said auxiliary local or remote power supply source is selected from the group consisting of: a single phase supply source; a dual or three phase supply source; a single, dual or three phase electricity distribution supply source; or, any suitable combination thereof.
